(19) United States
(12) Patent Application Publication
(10) Pub. No.: US 2022/0083982 A1
(43) Pub. Date: Mar. 17, 2022

(54) Time Tracking for Workflow and Project Management Applications

(71) Applicants: Michael Palandro, Palm Harbor, FL (US); Christian Wiggerman, Spring Hill, FL (US); Solomon Baba, Manchester (GB)

(72) Inventors: Michael Palandro, Palm Harbor, FL (US); Christian Wiggerman, Spring Hill, FL (US); Solomon Baba, Manchester (GB)

(21) Appl. No.: 17/022,992

(22) Filed: Sep. 16, 2020

(51) Int. Cl. G06Q 10/10; G06F 3/0486

(52) U.S. Cl. CPC G06Q 10/1091; G06F 3/0486; G06Q 10/105; G06Q 10/103

(57) ABSTRACT

Systems and methodologies for providing an employee(s) with a permission-based task and/or board drag and drop time tracking for workflow and project management applications are described and discussed herein. The embodiment discloses and details purposes and functions to enable specific and overall time tracking applications to be conducted for workflow and project specific tasks by employee(s) designated to perform work on these tasks, through the use of a unique, efficient and very easy to use clock in-clock out functionality, using a drag and drop progression activity, on a real time basis. The clock in-clock out time tracking activity is activated when the employee(s) drags and drops the task's and/or board's card assigned into the designated listing column for the employee(s) work to be conducted. Time conducted for the commencement of this task would start to accumulate when the employee(s) task's and/or board's card is placed in that specific work listing. Once the employee(s) has finished work on the task for the period of time that work was performed for that specific task or board; the employee(s) would clock out by dragging and dropping the task's card back into either the originating work process/list or to the next work process/list (that does not have the Time Tracking functionality enabled) which will represent a ‘paused’ status for the hourly work activity for that specific task. Thereby, ceasing the accumulation of time for that specific task and/or board work that was being conducted by the designated employee(s). The real time permission-based task and/or board drag and drop time tracking clock in-clock out process will function through all stages for the respective task and/or board activities to be executed to final completion for that employee(s) task activity. Other embodiments are described and claimed.

### TECHNICAL FIELD

The present disclosure is related generally to workflow/project management and more particularly, to systems and methods for providing time tracking for workflow and project management applications. The purpose is to enable specific and overall time tracking to be definitively identified; through a systemic “clock in-clock out” functionality. Allowing a real time recognition for employee time, with regard to work conducted upon a specific task, to be directly recorded as performed within the format and functionality of a business structure, as a time tracking system of record, ongoing during a workflow/project.

### BACKGROUND

The presented application, time tracking for workflow and project management applications, embodies functionality and technology discussed herein; may be accessed through a business format and structure technology platform having capability commensurate with the technical requirements necessitated by the time tracking for workflow and project management applications, referenced herewith, for all that it teaches without exclusion of any portion thereof.

Before proceeding to the remainder of this disclosure, it should be appreciated that the disclosure may address some, or all of the shortcomings listed or implicit in this Background section. However, any such benefit is not a limitation on the scope of the disclosed principles, or of the attached claims, except to the extent expressly noted in the claims.

Additionally, the discussion of technology in this Background section is reflective of the inventors' own observations, considerations, and thoughts, and is in no way intended to be, to accurately catalog, or to comprehensively summarize any prior art reference or practice. As such, the inventors expressly disclaim this section as admitted or assumed prior art. Moreover, the identification or implication herein of one or more desirable courses of action reflects the inventors' own observations and ideas and should not be assumed to indicate an art-recognized desirability.

### BRIEF DESCRIPTION OF SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a schematic view of the internal components of a personal electronic device constructed in accordance with the embodiment of the present disclosure; and

FIG. 2 illustrates the time tracking clock in-clock out functionality. The diagram projects tasks which are indicated for processing and includes employees to perform the task. The employees' clock-in to each stage of the task's process by dragging and dropping their task/cards into that process/list step of the workflow to be completed. The employees' respective task's card will remain, in the ‘clocked in’ designation for the extent of the period that the employee is conducting activities to accomplish that task. As the diagram illustrates this activity will be conducted until the assigned task is completed.

It should be understood; that the drawings are not necessarily to scale and that the disclosed embodiments are illustrated diagrammatically and in partial views. It should be further understood; that this disclosure is not to be limited to the distinct embodiments illustrated herein.

### DETAILED DESCRIPTION

Before presenting a detailed discussion of embodiments of the disclosed principles, an overview of certain embodiments is given to aid the reader in understanding the later discussion. As noted above the time tracking clock in-clock out functionality possesses capability commensurate with the technical requirements necessitated by the time tracking for workflow and project management with various applications including but not limited to payroll and billable hours applications, in addition to all other activity which would have need to use or refer to any and all time related information created by employees conducting tasks in relation to a required process to be completed.

The functionality of the referenced application is based upon methodologies and frameworks associated with managing projects and workflows. These methodologies and frameworks include the ability to use a unique clock in-clock out time tracking functionality which allows for the real time tracking accountability for employee time conducted during the workflow/projects to be completed. It should be noted that the details included with the embodiments disclosed in describing the clock in-clock out functionality, specifically refers to employee time tracking, however, a broader spectrum is considered, in that team and other entities within and outside the confines of specific employee defined recognition, may by implied or otherwise provided access, for active participation in using a designated clock in-clock out time tracking functionality to conduct workflow/projects. A task may be defined as any and all activities required but not limited, to complete a plan, process, procedure or function required either by the enterprise, client or other concerned party. As such the identification proffered by the word task in this embodiment may have other identifications pertinent to usage in process, terminology or as otherwise may be deemed applicable by the enterprise responsible for conducting the activity to be performed.

The unique clock in-clock out time tracking functionality is conducted through the workflow structure when an employee, assigned to a specific task, commences to conduct work on that task. Upon work commencement the employee would move their task's card, by a drag and drop action, into a specific in-progress listing column for that task. Time conducted for the commencement of this task would start to accumulate when the employee's task's card is placed in that specific in-progress listing. Once the employee has finished work on the task for the period of time that work was performed for that specific task; the employee would drag and drop their task's card back into a non-progression column listing; i.e. a pause or in waiting status which would either be situated between in process steps required to be executed or returned to the originating list process column as a result of task work remaining to be completed for that particular task activity. Thereby, ceasing the accumulation of time for that specific task they were conducting work.

The clock in-clock out time tracking functionality presented herein, precludes an employee from clocking into more than one specifically assigned task at a time. Ensuring that improper hourly activity, through duplications, will not occur.

If adjustments are required, regarding any validly deemed reason, for clocked in-clocked out times that were accrued by an employee, who was conducting a specific task or board; the project owner is the only individual that will have the authority to alter the times that were systematically recorded.

The clock in-clock out time tracking functionality is enabled when the assigned Project Manager for that task changes the options of the particular processes/lists to allow time tracking to be performed during that particular process/list. The project manager also has the ability to enable the time tracking functionality irregardless if a list/process is in a state of activity or inactivity; thereby, allowing the project manager the authority to establish the time tracking functionality at any list/process milestone for workflow activity to be conducted. In the functionality of the noted workflow activity, a list would be synonymous with the term “process” required by the project that tasks must progress through in order for the project to come to completion.

Establishment of the clock in-clock out time tracking functionality is represented when a ‘process/list’ is set up displaying workflow/project requirements, positioned as in-queue representations before commencement of in-progress, through all required stages to be performed, for that specific task to achieve completion. An employee, for example, executing a specific task, would be in a ‘pause’ status until actual time would be performed for that specific task. The actual times, when commenced by the employee, would be systemically actuated, when the employee drags and drops the assigned task's card into an in-progress listing for that specific task. Once the employee has finished performing work for that specific task, the employee would clock out by dragging and dropping the specific task's card back into the originating process/list or to the next process/list (that does not have Time Tracking enabled) which will represent a ‘paused’ status for the hourly work activity for that specific task. The real time tracking clock in-clock out process will function through all stages for the respective task activities to be executed to final completion for that task activity.

Time tracking for employee work times performed for assigned tasks in conjunction with a workflow/project may be reflected in generated reports for varying periods of activity time which may encompass summary or specific time periods for prior years up through the current day of hourly activity conducted. The reported hourly work information, systematically recorded through the time tracking functionality, can be filtered to generate employee payroll for any designated period. The breakdown of employee hours can be displayed by specific task, by completed workflow/project or all workflow/projects whether completed or not for a certain time-period. The time tracking application is also capable of specifically identifying client hours for billing purposes which are filterable to show task time activity conducted for a client, showing employee executed times, as specifically task activity broken-down by client billing period.

The functionality of the time tracking application permits employees the ability to view the work hours they have performed in real time by retrieving work time executed and accumulated for the selected time period. The time worked can be broken-down in summary and/or by specific task, including dates work was performed.

The project owner, through use of the stated time tracking application's functionality will have complete access to review all employee time worked in summary, or by specific task. The compilation of these conducted hours can be compiled in any number of ways to depict needed representation of any workflow/project.

The time tracking application will convey employee recorded work time completed for review in a calendar format, by employee or workflow/project, in summary or specific to task conducted activity; as well as, which client, as applicable, the performed work was conducted.

With this overview in mind and turning now to a more detailed discussion in conjunction with the attached figures, the techniques of this present disclosure are illustrated as being implemented in or via a suitable device environment. The following device description is based on embodiments and examples within which or via which the disclosed principles may be embodiments that are not explicitly described herein.

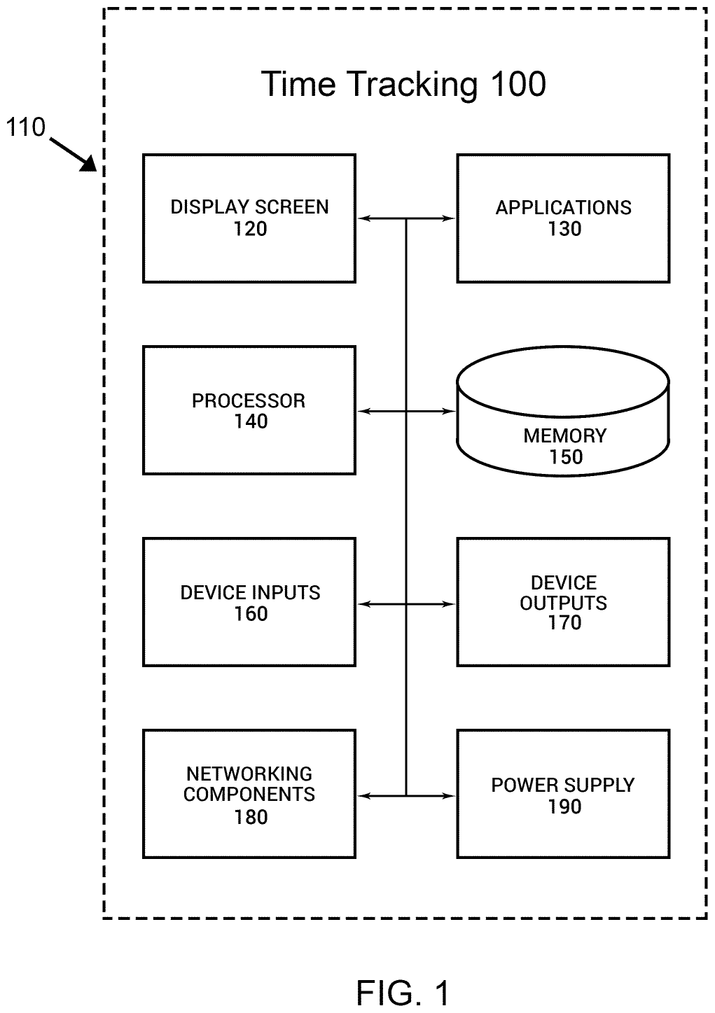

Referring now to FIG. 1, a personal electronic device (100) is depicted upon which the time tracking for workflow and project management hours applications can be accessed at (110). In the illustrated embodiment, the components of the personal electronic device (100) include a display screen (120), applications (e.g. programs) (130), a processor (140), a memory (150), one or more device inputs (160), and one or more device outputs (170). The personal electronic device (100) may be a mobile device, such as a smartphone, a laptop computer, a tablet computer (or pad), an electronic book (eBook reader, or other mobile or personal electronic devices that may be used to communicate wirelessly (or via a fixed link) and allow the user to view and share information. Moreover, the personal electronic device (100) may also be any computer, such as a desktop computer, server, or processor-based device that may use fixed (or wireless) links to communicate with other components and devices.

The display screen (120) may be connected to the processor (140) and memory (150) of the personal electronic device (100). When a user accesses the personal electronic device (100), the display screen (120) may visually represent the encoded software of the operating system of the personal electronic device (100) saved within the memory (150). Additionally, the display screen (120) may visually show the applications (130) accessed by the user which also may be stored within the memory (150) of the personal electronic device (100). The display screen (120) may have the added benefit of being operable as a device input (160). As a device input (160) the display screen (120) may respond to the touch of a user or a stylus to allow the user to input information into the personal electronic device (100) regarding the operation of programs or applications (130) stored within the personal electronic device (100). Additionally, as a device input (160), the display screen (120) may be able to scan and recognize a user's fingerprints, if a user places their finger within a certain portion of the display screen (120) for recognition and input.

The processor (140) can be any of a microprocessor, microcomputer, application-specific integrated circuit, or the like. For example, the processor (140) can be implemented by one or more microprocessors or controllers within an integrated circuit design. Similarly, the memory (150) may reside on the same integrated circuit as the processor (140). The memory (150) may include a random-access memory (i.e., Synchronous Dynamic Random-Access Memory (SDRAM), Dynamic Random-Access Memory (DRAM), RAMBUS Dynamic Random-Access Memory (RDRM) or any other type of random-access memory device or system). Additionally, or alternatively, the memory (150) may include a read only memory (i.e., a hard drive, flash memory or any other desired type of memory device).

The information that is stored by the memory (150) can include program code associated with one or more operating systems or applications (130) as well as informational data. Although the memory (150) is usually located locally within the personal electronic device (100), the memory (150) may be accessed by the networking components (180) if it is located remotely on a network server or cloud-based computing component. The operating system and applications (130) are typically implemented via executable instructions stored in a non-transitory computer readable medium within the memory (150) to control basic functions of the personal electronic device (100). These functions may include interaction among various internal components of the personal electronic device (100) and storage and retrieval of applications (130) and data to and from the memory (150).

With respect to the applications (130) stored within the memory (150), these typically utilize the operating system to provide more specific functionality. In an embodiment of the present disclosure, the time tracking for workflow and project management applications (110) may be a mobile application located within the memory (150) of the personal electronic device (100). Many applications (130) stored within the memory (150) may provide standard or required functionality of the personal electronic device (100). However, in other cases applications (130) such as the time tracking for workflow and project management applications (110) of the disclosure provide optional or specialized functionality, and maybe supplied by third party vendors.

As stated above the personal electronic device (100) may have a device input (160) and a device output (170). Examples of the device input (160) and device output (170) may include a touch screen or a physical keyboard, a stylus, a microphone, a camera, a speaker, wireless interface, infrared interfaces, and/or other input/output interfaces which may be present on the personal electronic device (100). A user may input information through the device input (160) which would then be sent to the processor (140) and memory (150) to execute the inputted information. Furthermore, the device output (170) may produce the required output, either visually or audibly, dependent on the execution of the applications (130) or commands executed by the processor (140) of the personal electronic device (100).

The wireless technologies and interfaces that may be used by the corresponding components of the personal electronic device (100) may include a Bluetooth interface, and Institute of Electrical or Electronic Engineers (IEEE) 802.11 compliant (or Wi-Fi) wireless interface, a near field communication (NFC) link, an Infrared Data Association interface, a Radio-Frequency identification interface or a radio frequency transponder, a reflection antenna chip, cellular interface, and or any other wireless technology interface that may be applicable to the personal electronic device. These networking components (180) provide wireless networking functionality, although wired networking may additionally or alternatively, be supported.

Moreover, a power supply (190), such as a battery or fuel cell, may be included for providing power to the personal electronic device (100) and its components. All or some of the internal components communicate with one another by way of one or more shared or dedicated internal communication links (190), such as an internal bus. Through these internal communication links (190), power and data may be shared between the multiple internal components of the personal electronic device (100).

In an operational setting, the personal electronic device (100) is programmed such that the processor (140) and memory (150) interact with the other components of the personal electronic device (100) to perform a variety of functions. The processor (140) may communicate with the memory (150) to implement various modules and execute programs for different activities such as launching an application, transferring data, and toggling through various graphical user interface objects representing thumbnail images of executable programs stored within the memory (150).

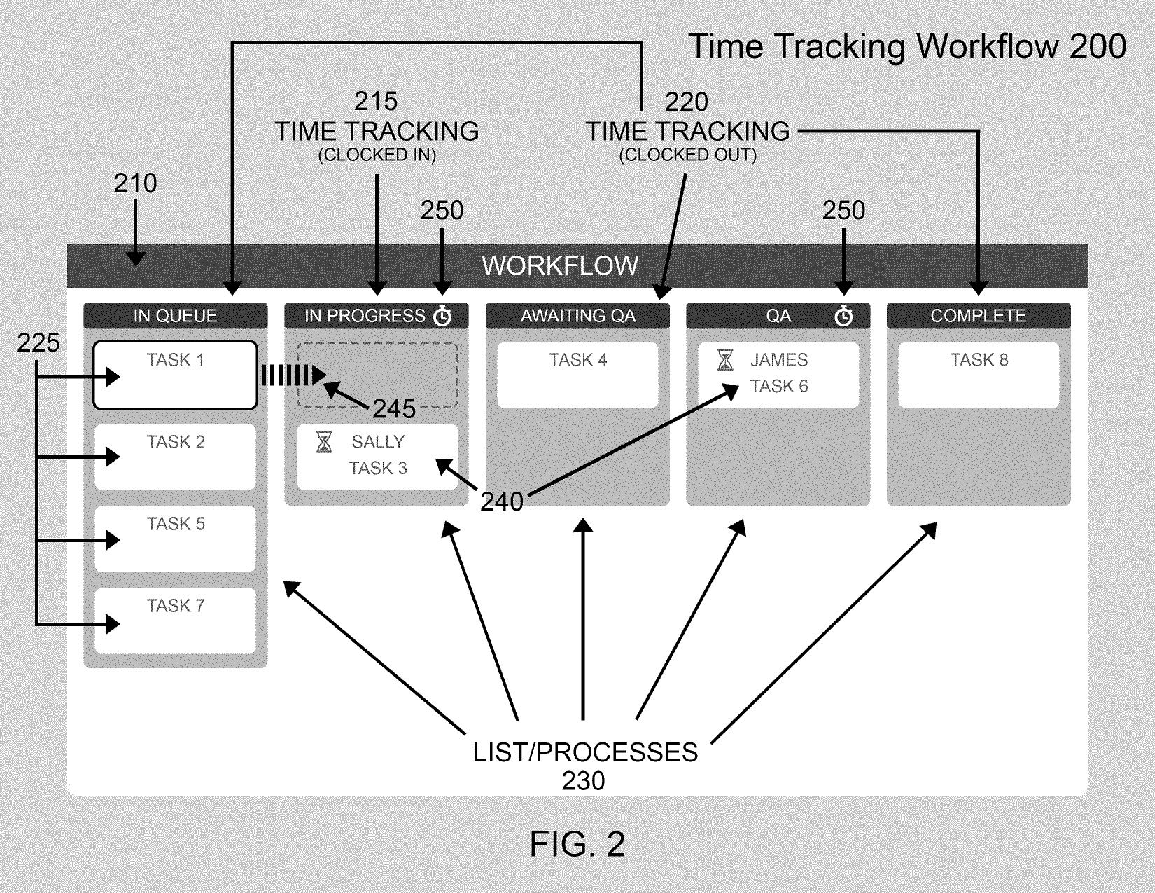

Referring now to FIG. 2, the illustrated architecture for the time tracking for workflow and project management applications (200), horizontally shows the components and workflow stages incorporated within the time tracking for workflow and project management applications developed (210) to complete an initially and ongoing, as applicable, required time tracking workflow with clock in (215) and clock out (220) functionality accomplished. The workflow (210) consists of processes/lists (230), task's cards (225) to be performed which in aggregate represent the complex of activities identified as the processing steps and resources which characterize the component functionality for the time tracking for workflow and project management applications. Represented within each task to be executed is shown an employee (240) actively performing the noted task.

The workflow (210) represents the group of designated stages of processes/lists (230) to be executed, in order to complete the indicated stage of the project encompassed by this workflow (210) grouping. As illustrated, the workflow (210) process has been established by lists (230) containing tasks (225) to be performed. The identified tasks' cards (225) will also note the employee(s) (240) actively performing the work activity specific for that task (225).

After the workflow (210) has been established, with the time tracking's clock in (215)-clock out (220) functionality enabled through the process/list options. The enabled clock in (215)-clock out (220) time tracking functionality is identified by a clock icon (250) at the applicable process/list (230) designation for the specific process to be conducted. This identification of a clock icon can be depicted in any number of other ways, i.e. different icons, symbols, or words however is only depicted as a clock icon for the purpose of identification in this embodiment's disclosure. Performance of the specific task (225) is actuated by an employee (240) dragging and dropping (245) the designated task's card (225) into the appropriate in progress/list (230) processing stage indicating which work is to be performed. The effect of this task's (225) card movement (245) will start the clock in (215) time tracking function by storing a timestamp within the database, on a real time activity system of record.

At the point of work progression that the employee(s), performing the task (240) has completed work for the task (225), which could be for a period of time worked on that task (225) or be as a result of completing all work required for that task (225); the designated employee(s), performing the task (240) performs a clock out (220) activity, by dragging and dropping (245) the designated task (225) into a process/list not characterized with an enabled time tracking functionality, but is represented by a work pause status. The work pause status will be embodied by the task being located within a process/list (230) that does not have time tracking enabled and is denoted by a process encompassing a wait state which is required to be performed for the designated specific task (225). At the real time point of performing a clock out (220), employee(s) (240) time(s) discontinue accruing for that task (220) and will be recorded as a timestamp within the database. It is important to note, that an employee(s) is precluded from clocking in (215) to more than one task (225) in progress; thereby, eliminating erroneous time duplications from occurring.

The unique workflow time tracking (200) clock in (215)-clock out (220) functionality represents a real time system of record, directly having a multitude of immediate review and usage applications, including but not limited to, payroll, client billing, workload management, workflow progress, workflow efficiency, workflow awareness, workload balance and many other applications as may be required by an enterprise. Any subsequently confirmed adjustments to the systemic real time tracked hourly information recorded may only be conducted by the project owner, allowing for a check and balance independent control over workflow time tracked (200) employee(s) (240) hours.

It will be appreciated that various systems and processes have been disclosed herein. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

What is claimed is:

1. A system for providing a Time Tracking for Workflow and Project Management Applications comprising:
a non-transitory computer readable medium having stored thereon data and programmable code, the data comprising a programmed code to create a permission-based time tracking employee task and/or board drag and drop time tracking clock in-clock out protocol; and
a personal electronic device programmed and configured to manage a workflow and project management comprising a permission-based time tracking employee task and/or board drag and drop time tracking clock in-clock out application functionality in conjunction with the non-transitory computer readable medium by managing, tracking and executing workflow/project management time tracking by a clock in-clock out functionality for task and board processing by employee(s), creating a real time system of record for identifying all times performed for workflow and projects, by specific task, conducted by employee(s), in accordance with the permission-based task and/or board drag and drop time tracking clock in-clock out protocol.

2. The system in accordance with claim 1, wherein the personal electronic device is further programmed and configured to implement a permission-based task and/or board drag and drop time tracking clock in-clock out format which permits a time tracking functionality to be conducted through a workflow structure whereby an employee(s), executing a specific task or board, to clock in when commencing work on the specifically assigned task or board and clocking out upon completion of work conducted, using a drag and drop function on a real time basis.

3. The system in accordance with claim 1, the time tracking functionality is actuated when an employee(s) moves a task and/or board card by a drag and drop action, into a specific in progress listing column for the specific project or workflow; conducting this drag and drop activity, the employee(s) becomes clocked-in to the task to be executed; at completion of work performed on the specific task by the clocked in employee(s), the employee(s) clocks out by conducting a drag and drop activity, moving the assigned task and/or board that work was performed either back to the previous list or to an in waiting status prior to progressing to the next required stage of processing to be conducted, this will cease time tracking from being accrued by the employee(s) for that task and/or board, on a real time basis.
